(19) United States
(12) Patent Application Publication
(10) Pub. No.: US 2007/0230301 A1
(43) Pub. Date: Oct. 4, 2007

(54) OPTICAL DISC APPARATUS AND OPTICAL DISC DISCRIMINATING METHOD

(76) Inventor: Yoshinori Tazaki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,621

(22) Filed: Mar. 22, 2007

(30) Foreign Application Priority Data
Mar. 30, 2006 (JP) 2006-095149

(51) Int. Cl. G11B 7/00

(52) U.S. Cl. 369/53.2; 369/44.27; 369/44.29

(57) ABSTRACT

An optical disc apparatus includes an optical pickup which irradiates a first laser beam for reproducing a first DVD medium, or a second laser beam for reproducing a second DVD medium onto a installed optical disc, and receives the reflected light from the installed optical disc, a controller determines that the installed optical disc is the second DVD medium when a value by normalizing the amplitude of a RF signal generated from the reflected light with a coefficient is larger than first threshold value and smaller than a second threshold value, and the controller determines that the installed optical disc is the first DVD medium when the value is not larger than first threshold value and smaller than a second threshold value.

### CROSS-REFERENCE TO RELATED APPLICATIONS

This application is based upon and claims the benefit of priority from prior Japanese Patent Application No. 2006-095149, filed Mar. 30, 2006, the entire contents of which are incorporated herein by reference.

### BACKGROUND OF THE INVENTION

1. Field of the Invention

This invention relates to an optical disc apparatus and an optical disc discriminating method which discriminate a plurality of types of optical discs that are the same in the distance from their surface to their recording layer and differ in the reproducing wavelength.

2. Description of the Related Art

A CD and a DVD have been discriminated without focusing, since they differ in the distance from the disc surface to the recording layer. However, since an HD DVD (High-Definition Digital Versatile Disc) and a DVD have the same thickness, it is difficult to discriminate them without focusing.

Jpn. Pat. Appln. KOKAI Publication No. 2006-31779 has disclosed the technique for discriminating between an HD DVD and a DVD using a laser beam with a HD DVD reproducing wavelength.

Since the diameter of an HD DVD laser spot is about half that of a DVD laser spot and the laser power of the former is about half of that of the latter, the laser density of the former is about twice that of the latter. In this state, if focusing is done on a DVD recording medium with an HD DVD laser, there is a possibility that the data will be erased.

### BRIEF SUMMARY OF THE INVENTION

According to an aspect of the present invention, there is provided An optical disc apparatus capable of installing a optical disc selected from a plurality of types of optical discs including a first Digital Versatile Disc (DVD) medium including a first track width, and a second Digital Versatile Disc (DVD) medium including a second track width is shorter than the first track width is installed, the optical disc apparatus comprising: a motor which rotates the installed optical disc; an optical pickup which irradiates a first laser beam for reproducing the first DVD medium, or a second laser beam for reproducing the second DVD medium onto the installed optical disc through an objective lens, and receives the reflected light from the installed optical disc; a moving mechanism which moves the optical pickup across the radius of the optical disc; a signal generating section which generates a focus error signal, a tracking error signal, and RF signal using the reflected light, and outputs the generated signals; a driving section which drives the optical pickup according to the focus error signal and the tracking error signal for performing to a focus control and a track positioning control; and a controller which controls the motor, the signal generating section, and the driving section, the controller controls the moving mechanism and moves the optical pickup at a position opposite to a predetermined area of the installed optical disc, the controller controls the optical pickup for irradiating the first laser beam onto the rotating installed optical disc, the controller controls the driving section and detects a amplitude of the RF signal when the first laser beam is focused on the predetermined area, the controller determines that the installed optical disc is the second DVD medium when a value by normalizing the amplitude of the RF signal with a coefficient is larger than first threshold value and smaller than a second threshold value, and the controller determines that the installed optical disc is the first DVD medium when the value is not larger than first threshold value and smaller than a second threshold value.

### BRIEF DESCRIPTION OF THE SEVERAL VIEWS OF THE DRAWING

FIG. 1 is a block diagram showing a general configuration of an optical disc apparatus according to an embodiment of the present invention;

FIG. 2 is a flowchart to help explain the process of discriminating optical discs according to the embodiment;

FIG. 3 shows a SBAD signal and a focus error signal which are obtained when the optical disc is a CD;

FIG. 4 shows a SBAD signal and a focus error signal which are obtained when the optical disc is a DVD/HD DVD;

FIG. 5 shows an amplitude of Aₙ in the case of a read-only DVD-ROM or a recorded recording DVD medium;

FIG. 6 shows amplitude Aₙ in the case of a HD DVD; and

FIG. 7 shows amplitude Aₙ in the case of a unrecorded recording DVD medium.

### DETAILED DESCRIPTION OF THE INVENTION

Hereinafter, referring to the accompanying drawings, an embodiment of the present invention will be explained.

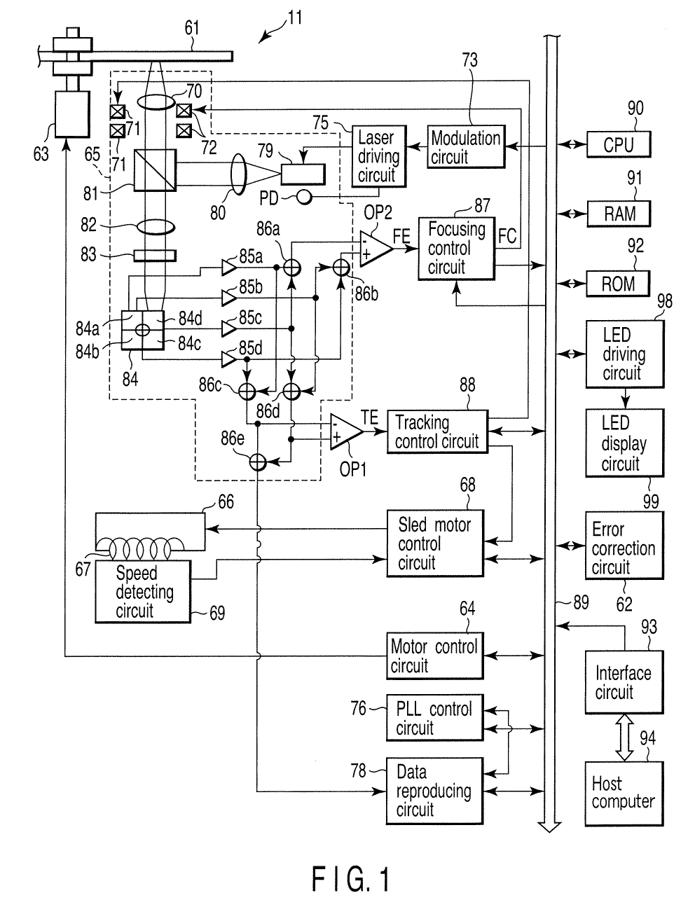

FIG. 1 is a block diagram showing the configuration of an optical disc apparatus according to the present invention.

Although an optical disc 61 set in an optical disc apparatus 11 is an optical disc capable of recording user data or a read-only optical disc, an explanation will be given in the embodiment on the assumption that the optical disc 61 is a recordable multilayer-structure optical disc. A DVD-R may be used as an optical disc whose information recording surface has a multilayer structure. The present invention is not limited to this and may be applied to any optical disc, as long as the optical disc enables multilayer recording.

At the information recording surface of the optical disc 61, a land track and a groove track are formed in a spiral manner. The optical disc 61 is rotated by a spindle motor 63.

Information is recorded onto and reproduced from the optical disc 61 by an optical pickup 65 (the part enclosed by a broken line at left in FIG. 1). The optical pickup 65 is connected to a sled motor 66 via a gear. The sled motor 66 is controlled by a sled motor control circuit 68.

A speed detecting circuit 69 positioned under the sled motor 66, which detects the moving speed of the optical pickup 65, is connected to the sled motor control circuit 68. The speed signal of the optical pickup 65 detected by the speed detecting circuit 69 is sent to the sled motor control circuit 68. A permanent magnet (not shown) is provided to the fixed part of the sled motor 66. A driving coil 67 is excited by the sled motor control circuit 68, thereby driving the optical pickup 65 across the radius of the optical disc 61.

On the optical pickup 65, there is provided an objective lens 70 supported by a wire or a plate spring (not shown). The objective lens 70 is driven by driving coils 71, 72 in such a manner that it can move in the tracking direction (or the direction perpendicular to the optical axis of the lens) and in the focusing direction (or in the direction of the optical axis of the lens).

A modulation circuit 73, when information is recorded onto the optical disc 61, receives an information signal to be recorded via an interface circuit 93 and a bus 89 from a host computer 94, and modulates the information signal by a modulation method determined in the standard of the optical disc 61 (for example, by the 8-16 modulation method). A laser driving circuit 75 supplies a write signal to a semiconductor laser diode 79 on the basis of the modulated data supplied from the modulation circuit 73 when information is recorded onto the optical disc 61 (or when marks are formed). In addition, the laser driving circuit 75, when the information is reproduced, supplies a read signal smaller than the write signal to the semiconductor laser diode 79.

The semiconductor laser diode 79 generates a laser beam according to the signal supplied from the laser driving circuit 75. The laser beam emitted from the semiconductor laser diode 79 passes through a collimator lens 80, a half prism 81, and the objective lens 70 and is irradiated onto the optical disc 61. The reflected light from the optical disc 61 passes through the objective lens 70, the half prism 81, a condenser lens 82, and a cylindrical lens 83 and is directed to a photodetector 84.

The semiconductor laser diode 79 is composed of three semiconductor laser diodes which emit a CD laser beam (or an infrared laser beam with a wavelength of 780 nm), a DVD laser beam (or a red laser beam with a wavelength of 650 nm), and an HD DVD laser beam (or a blue-violet laser beam with a wavelength of 405 nm). These semiconductor laser diodes may be housed in a single CAN package. Alternatively, they may be housed in three independent CAN packages and provided separately on the base of the optical pickup 65. The configuration and arrangement of the optical system are changed suitably according to the configuration of the semiconductor laser.

Of the parts constituting the optical system, the objective lens 70 is designed to cause an HD DVD laser beam to converge on the disc properly. The optical system includes an aberration correction element (e.g., a diffraction element or a phase correction element) for suppressing the aberration developed when a DVD laser beam or a CD laser beam is used and a numerical aperture limiting element (e.g., a liquid-crystal shutter or a diffraction element) for limiting the numerical aperture for the objective lens 70 when a DC laser beam is used.

The photodetector 84 is composed of, for example, quadrant light-detecting cells 84a to 84d. The output signals of the light-detecting cells 84a to 84d of the photodetector 84 are supplied via current/voltage conversion amplifiers 85a to 85d to an adder 86a for adding the outputs of the light-detecting cells 84a and 84c, an adder 86b for adding the outputs of the light-detecting cells 84b and 84d, an adder 86c for adding the outputs of the light-detecting cells 84a and 84d, and an adder 86d for adding the outputs of the light-detecting cells 84b and 84c. The outputs of the adders 86a, 86b are supplied to a differential amplifier OP2. The outputs of the adders 86c, 86d are supplied to a differential amplifier OP1.

The differential amplifier OP2 generates a focus error signal FE corresponding to the difference between the outputs of the adders 86a, 86b. The focus error signal FE is supplied to a focusing control circuit 87. The output signal FC of the focusing control circuit 87 is supplied to a focusing driving coil 72. On the basis of the output signal FC of the focusing control circuit 87, the focusing driving coil 72 performs control in such a manner that the laser beam is always just focused on the recording surface of the optical disc 61. The focusing control circuit 87 has the function of measuring the amplitude of the focus error signal FE. The focus control circuit 87 outputs the measured value to a CPU 90 via a bus 89.

The differential amplifier OP1 generates a tracking error signal TE corresponding to the difference between the outputs of the adders 86c, 86d. The tracking error signal TE is supplied to a tracking control circuit 88. The tracking control circuit 88 generates a tracking driving signal according to the tracking error signal TE. The tracking driving signal output from the tracking control circuit 88 is supplied to the driving coil 71 which drives the objective lens 70 in the direction perpendicular to the optical axis. On the basis of the tracking driving signal, the driving coil 71 performs control in such a manner that the laser beam is irradiated onto a specific place of the recording surface of the optical disc 61. The tracking error signal TE used in the tracking control circuit 88 is also supplied to the sled motor control circuit 68.

By performing the focusing control and the tracking control as described above, a signal faithful to the recorded information can be obtained from the sum signal of the output signals of the light-detecting cells 84a to 84d of the photodetector 84, that is, the output sum signal RF of the adder 86e which adds the output signals of the adders 86c, 86d. The output sum signal RF is supplied to a data reproducing circuit 78.

Next, the data reproducing circuit 78 in the lowest part of FIG. 1 reproduces the read-out recorded data on the basis of the reproduce clock signal from a PLL circuit 76. The data reproducing circuit 78 has the function of measuring the amplitude of the signal RF and outputs the measured value to the CPU 90 via the bus 89.

The sled motor control circuit 68 controls the sled motor 66 and moves the body of the optical pickup 65 in such a manner that the objective lens 70 is located near the central position of the optical pickup 65.

The motor control circuit 64, sled motor control circuit 68, modulation circuit 73, laser driving circuit 75, PLL circuit 76, data reproducing circuit 78, focusing control circuit 87, and tracking control circuit 88 can be configured in a single LSI chip. These circuits are controlled by the CPU 90 via the bus 89. The CPU 90 controls the optical disc recording and reproducing apparatus comprehensively according to the operation command supplied from the host computer 94 via an interface circuit 93. Moreover, the CPU 90 uses a RAM 91 as a working area and performs specific control according to a program including a process related to the embodiment recorded in a ROM 92.

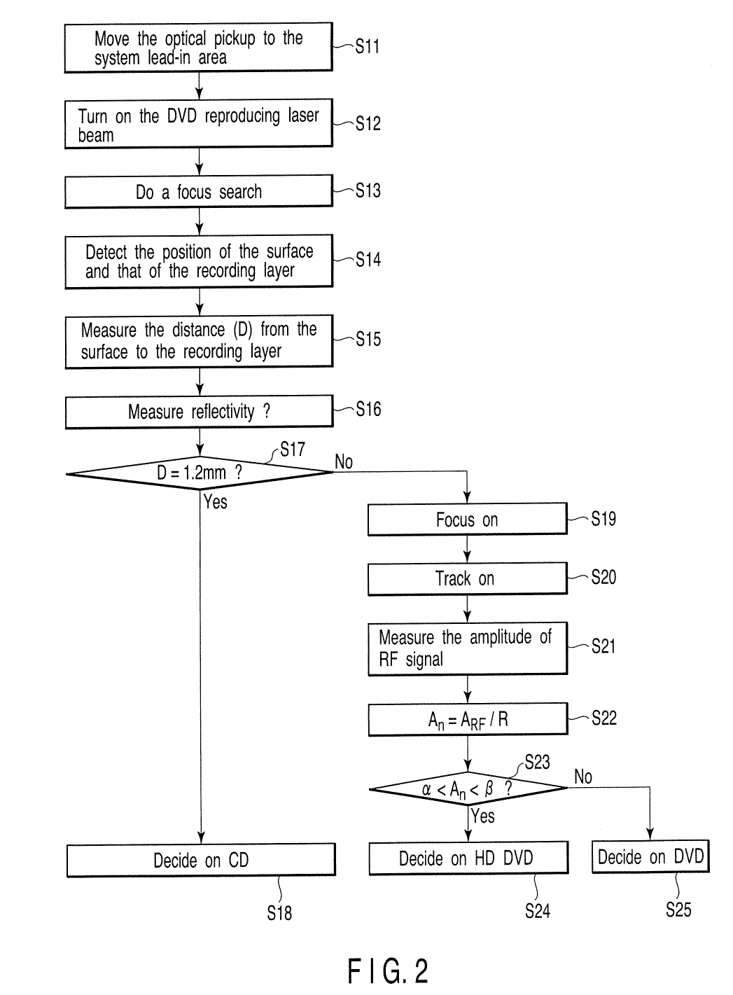

FIG. 2 shows a processing flowchart for a disc discriminating process. The disc discriminating process is carried out at the time when the optical 61 disc is installed in the optical disc apparatus 11.

When the processing flow is started, first, the CPU 90 moves the optical pickup 65 to a specific radial position so that the laser beam emitted from the optical pickup 65 may be irradiated onto a specific position of the optical disc 61 (step S11).

Suppose the position onto which the laser beam is irradiated is set in the range of 23.3 mm to 23.8 mm in radius. In the case of HD DVD, the area corresponds to the system lead-in area. The system lead-in area has specific information in the form of embossed pre-pits.

Next, the CPU 90 rotates the optical disc 61 at a specific speed. Then, of the semiconductor laser diodes 79, the CPU 90 turns on the DVD-laser-beam-emitting semiconductor laser at a DVD reproducing power level. Moreover, the CPU 90 sets the optical system (including the aberration correction element and numerical aperture limiting element) to the DVD reproduce mode (step S12).

The CPU 90 carries out a focus search (step S13). In the focus search, the CPU 90 drives the focusing driving coil 72, thereby moving the objective lens 70 in the focusing direction. The adder 86e supplies the SBAD signal (signal and sub-beam add signal, or the sum of the output signals of the amplifiers 85a to 85d) to the CPU 90.

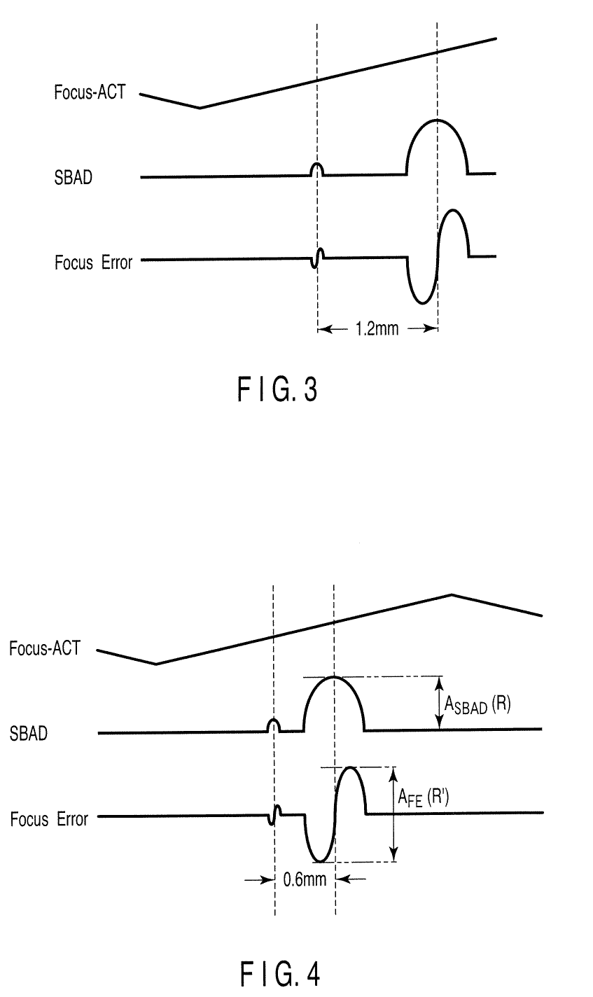

The CPU 90 detects the position of the surface and that of the recording layer from the waveform of the SBAD signal (step S14). FIG. 3 shows an SBAD signal and a focus error signal (Focus Error) obtained in the position (Focus-ACT) of the objective lens 70 when the optical disc 61 is a CD. FIG. 4 shows an SBAD signal and a focus error signal (Focus Error) obtained in the position (Focus-ACT) of the objective lens 70 when the optical disc 61 is a DVD or an HD DVD.

When the objective lens 70 is moved in the focusing direction, the moving distance of the objective lens 70 during the time from when the SBAD signal takes a maximal value until it takes a minimal value is detected, which makes it possible to detect the position of the surface of the optical disc 61 and that of its recording layer. Furthermore, by detecting the moving distance of the objective lens 70 between zero-cross points of the focus error signal (Focus Error), it is possible to detect the position of the surface of the optical disc 61 and that of its recording layer.

The CPU 90 measures the distance from the surface of the optical disc 61 to its recording layer from the position of the surface and that of the recording layer sensed in step S14 (step S15).

The reflectivity R of the optical disc 61 is measured (step S16). In the embodiment, let amplitude A_{FE} (reflectivity R′) of the Focus Error signal (Focus Error) measured by the focusing control circuit 87 in a focus search or amplitude A_{SBAD} (reflectivity R) of the SBAD signal measured by the data reproducing circuit 78 in a focus search.

The CPU 90 determines whether the distance measured in step S15 is 1.2 mm (step S17). If having determined that the distance is 1.2 mm (Yes in step S17), the CPU 90 determines that the optical disc 61 is a CD (step S18).

If having determined that the distance is not 1.2 mm (No in step S17), the CPU 90 focuses on the recording layer of the optical disc according to the position of the recording layer detected in step S14 (step S19). Then, the CPU 90 carries out tracking in such a manner the data recorded in the System Lead-in area is obtained correctly (step S20).

The data reproducing circuit 78 measures amplitude A_{RF} Of the RF signal (step S21) and supplies the measured value to the CPU 90. The CPU 90 calculates the following equation, thereby normalizing amplitude A_{RF} obtained in step S21 (step S22):

An=A_{RF}/R (R=A_{SBAD} or A_{FE})

In normalizing the amplitude by division, a specific coefficient or function may be used for amplitude A_{RF} Of the RF signal or reflectivity R.

The CPU 90 determines whether amplitude An is larger than threshold value a and smaller than threshold value β (step S23). If having determined that amplitude An is larger than threshold value α and smaller than threshold value β (Yes in step S23), the CPU 90 recognizes the optical disc 61 as an HD DVD (step S24). If having determined that the normalized amplitude An does not satisfy the condition that it is larger than threshold value α and smaller than threshold value β (No in step S23), the CPU 90 recognizes the optical disc 61 as a DVD (step S25).

Next, the above-described determining method will be explained.

In the case of a read-only disc, the RF signal obtained from the optical disc 61 in the focus-on and track-on state reflects light interference caused by the depth of a pit. In the case of a recording disc, the RF signal reflects light interference and contrasting resulting from a change in the film thickness of the recording layer. In short, it is seen that the RF signal depends on the wavelength. Therefore, according to the amplitude of the RF signal, it is possible to determine whether the optical disc is a DVD or an HD DVD. However, the magnitude (or amplitude) of the RF signal also depends on reflectivity. Accordingly, it is necessary to find value An by normalizing the amplitude of the RF signal with respect to reflectivity. As a result, it is possible to determine the type of an optical disc by dividing amplitude An by a certain threshold value α and β.

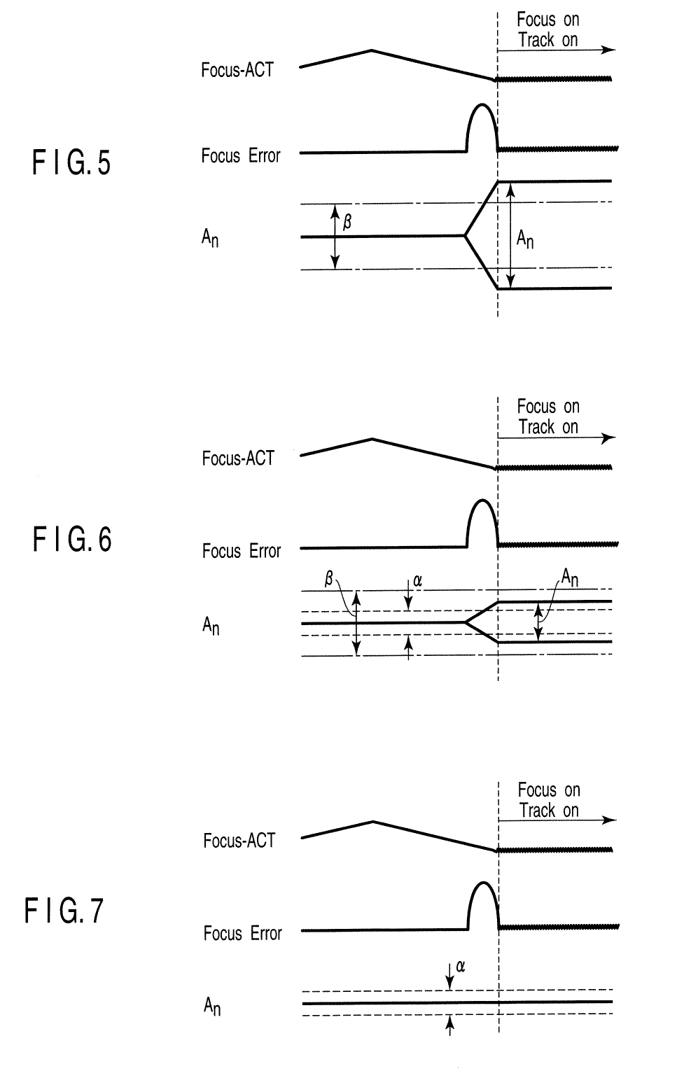

In the case of a read-only DVD-ROM or a recorded recording DVD medium, amplitude An becomes the largest, because the contrasting of the RF signal is clear (FIG. 5).

In the case of an HD DVD, although pits never are always formed in the system lead-in area, light-and-dark parts are less liable to appear, because there is less interference in a DVD laser differing in the reproducing wavelength. The spot diameter of the DVD laser is large for the pits in the HD DVD. For this reason, light-and-dark parts are much less liable to appear. Consequently, amplitude An becomes smaller (FIG. 6).

In the case of an unrecorded DVD recording medium, since there is no light-and-dark part on the disc, the amplitude of the RF signal is zero (FIG. 7).

Therefore, if the threshold value of the recording part (or the recorded area) of a DVD-ROM or a recording DVD medium is β, or if the threshold value of the unrecorded part of the recording DVD medium is α, it is possible to determine the optical disc as follows:

If An>β, the optical disc is recognized as a DVD disc (or a DVD-ROM or a recording DVD medium with a recording part) (FIG. 5).

If α<An<β, the optical disc is recognized as a DVD medium (FIG. 6).

If An<α, the optical disc is recognized as a DVD disc (an unrecorded recording DVD medium) (FIG. 7).

Here, threshold value α and β are determined suitably according to the reflectivity used in normalizing the RF signal (or amplitude A_{FE} of the focus error signal FE or amplitude A_{SBAD} Of the SBAD signal).

As described above, since a light beam with a DVD wavelength is used to determine the type of an optical disc without using a laser beam with an HD DVD wavelength, it is possible to discriminate optical discs without erasing the data.

Furthermore, an optical disc may be determined by measuring the amplitude of the SBAD signal in a state where tracking on is not done after focusing on is done and normalizing the amplitude with respect to the reflectivity.

What is claimed is:

1. An optical disc apparatus capable of installing a optical disc selected from a plurality of types of optical discs including a first Digital Versatile Disc (DVD) medium including a first track width, and a second Digital Versatile Disc (DVD) medium including a second track width is shorter than the first track width is installed, the optical disc apparatus comprising:
a motor which rotates the installed optical disc;
an optical pickup which irradiates a first laser beam for reproducing the first DVD medium, or a second laser beam for reproducing the second DVD medium onto the installed optical disc through an objective lens, and receives the reflected light from the installed optical disc;
a moving mechanism which moves the optical pickup across the radius of the optical disc;
a signal generating section which generates a focus error signal, a tracking error signal, and RF signal using the reflected light, and outputs the generated signals;
a driving section which drives the optical pickup according to the focus error signal and the tracking error signal for performing to a focus control and a track positioning control; and
a controller which controls the motor, the signal generating section, and the driving section,
the controller controls the moving mechanism and moves the optical pickup at a position opposite to a predetermined area of the installed optical disc,
the controller controls the optical pickup for irradiating the first laser beam onto the rotating installed optical disc,
the controller controls the driving section and detects a amplitude of the RF signal when the first laser beam is focused on the predetermined area,
the controller determines that the installed optical disc is the second DVD medium when a value by normalizing the amplitude of the RF signal with a coefficient is larger than first threshold value and smaller than a second threshold value, and
the controller determines that the installed optical disc is the first DVD medium when the value is not larger than first threshold value and smaller than a second threshold value.

2. The optical disc apparatus according to claim 1, wherein the controller controls the driving section for carrying out a focus search in state that the first laser beam is irradiated onto the predetermined area, and measures a distance from a surface of the installed optical disc to a recording layer of the installed optical disc and a reflectivity of the installed optical disc, and the coefficient is the reflectivity.

3. The optical disc apparatus according to claim 2, wherein the controller determines the installed optical disc as another optical disc when the measured distance is predetermined distance.

4. The optical disc apparatus according to claim 2, wherein the reflectivity is the amplitude of the focus error signal or a amplitude of an SBAD signal.

5. The optical disc apparatus according to claim 1, wherein the first DVD medium is a DVD-ROM or recording DVD medium, and the second DVD medium is a High-Definition Digital Versatile Disc (HD DVD).

6. An optical disc apparatus capable of installing a optical disc selected from a plurality of types of optical discs including compact disc, a first Digital Versatile Disc (DVD) medium including a first track width, and a second Digital Versatile Disc (DVD) medium including a second track width is shorter than the first track width is installed, the optical disc apparatus comprising:
a motor which rotates the installed optical disc
an optical pickup which irradiates a CD laser beam for reproducing the compact disc, a first laser beam for reproducing the first DVD medium, or a second laser beam for reproducing the second DVD medium onto the installed optical disc through an objective lens, and receives the reflected light from the installed optical disc;
a moving mechanism which moves the optical pickup across the radius of the optical disc;
a signal generating section which generates a focus error signal, a tracking error signal, and RF signal using the reflected light, and outputs the generated signals;
a driving section which drives the optical pickup according to the focus error signal and the tracking error signal for performing to a focus control and a track positioning control; and
a controller which controls the motor, the signal generating section, and the driving section,
the controller controls the moving mechanism and moves the optical pickup at a position opposite to a predetermined area of the installed optical disc,
the controller controls the optical pickup for irradiating the first laser beam onto the rotating installed optical disc,
the controller carries out a focus search by controlling the driving section and driving the optical pickup, and measures a distance from a surface of the installed optical disc to a recording layer of the installed optical disc and a reflectivity of the installed optical disc,
the controller determines that the installed optical disc is the compact disc when the measured distance is a predetermined distance,
the controller controls the driving section and measures a amplitude of the RF signal in state that the first laser beam is focused on the predetermined area when the measured distance is not the predetermined distance,
the controller determines that the installed optical disc as the second DVD medium when a value by normalizing the amplitude of the RF signal with a coefficient is larger than first threshold value and smaller than a second threshold value, and
the controller determines that the installed optical disc is the first DVD medium when the value is not larger than first threshold value and smaller than a second threshold value.

7. The optical disc apparatus according to claim 6, wherein the reflectivity is the amplitude of the focus error signal or a amplitude of an SBAD signal.

8. An optical disc discriminating method which discriminates a kind of an optical disc installed an optical disc apparatus capable of installing a optical disc selected from a plurality of types of optical discs including a first Digital Versatile Disc (DVD) medium including a first track width, and a second Digital Versatile Disc (DVD) medium including a second track width is shorter than the first track width is installed, the optical disc discriminating method comprising:
moving a optical pickup at a position opposite to a predetermined area of the installed optical disc;
irradiating a first laser beam for reproducing the first DVD medium onto the installed optical disc from the optical pickup;
controlling the optical pickup according to a focus error signal and tracking error signal which are generated from a reflected light and measuring a amplitude of a RF signal generated from the reflected light in state that the first laser beam is focused on the predetermined area;
determining the installed optical disc as the second DVD medium when a value by normalizing the amplitude of the RF signal with a coefficient is larger than first threshold value and smaller than a second threshold value; and
determining the installed optical disc as the first DVD medium when the value is not larger than first threshold value and smaller than a second threshold value.

9. The optical disc discriminating method according to claim 8, further comprising: measuring a distance from a surface of the installed optical disc to a recording area of the installed optical disc and a reflectivity of the installed optical disc by carrying out a focus search; and
wherein the coefficient is the reflectivity.

10. The optical disc discriminating method according to claim 8, further comprising: determining the installed optical disc as another optical disc when the measured distance is predetermined distance.

11. The optical disc discriminating method according to claim 9, wherein the reflectivity is the amplitude of the focus error signal or a amplitude of an SBAD signal.

12. The optical disc discriminating method according to claim 8, wherein the first DVD medium is a DVD-ROM or recording DVD medium, and the second DVD medium is a High-Definition Digital Versatile Disc (HD DVD).

13. An optical disc discriminating method which discriminates a kind of an optical disc installed an optical disc apparatus capable of installing a optical disc selected from a plurality of types of optical discs including a compact disc, a first DVD medium including a first track width, and a second DVD medium including a second track width is shorter than the first track width is installed, the optical disc discriminating method comprising:
moving a optical pickup at a position opposite to a predetermined area of the installed optical disc;
irradiating a first laser beam for reproducing the first DVD medium onto the installed optical disc from the optical pickup,
controlling and driving the optical pickup according to a focus error signal and tracking error signal which are generated from a reflected light, and measuring a distance from a surface of the installed optical disc to a recording area of the installed optical disc and reflectivity of the installed optical disc by carrying out a focus search in state that the first laser beam is irradiated onto the predetermined area;
determining the installed optical disc as the compact disc when the measured distance is predetermined distance;
controlling and driving the optical pickup using the focus error signal and measuring a amplitude of a RF signal generated from the reflected light in state that the first laser beam is focused on the predetermined area, when the measured distance is not predetermined distance;
determining the installed optical disc as the second DVD medium when a value by normalizing the amplitude of the RF signal with a coefficient is larger than first threshold value and smaller than a second threshold value; and
determining the installed optical disc as the first DVD medium when the value is not larger than first threshold value and smaller than a second threshold value.

14. The optical disc discriminating method according to claim 13, wherein the reflectivity is the amplitude of the focus error signal or a amplitude of an SBAD signal.
